(19) United States
(12) Patent Application Publication
(10) Pub. No.: US 2010/0049815 A1
(43) Pub. Date: Feb. 25, 2010

(54) Programmable and Extensible Multi-Social Network Alert System

(75) Inventors: George Vanecek, Madison, WI (US); John Waclawsky, Bartlett, IL (US); Nino Vidovic, Saratoga, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: MOBILE TRIBE LLC, Redwood City, CA (US)

(21) Appl. No.: 12/544,920

(22) Filed: Aug. 20, 2009

Related U.S. Application Data
(60) Provisional application No. 61/091,384, filed on Aug. 23, 2008.

(51) Int. Cl. G06F 15/16; H04L 29/06

(52) U.S. Cl. 709/206; 340/540; 726/1

(57) ABSTRACT

Methods, apparatus, and computer-readable media are presented regarding alert processing. An alert may be received or generated with respect to one or more portals, such as social-networking websites, enterprise servers, and other data sources. Requests associated with one or more portals may be received at an MTproxy. The request may come from an MTclient and may include state information about alerts. At the MTproxy, a user monitor thread is generated in response to the request. The user monitor thread may be associated with a user of the MTproxy. One or more alertlets associated with the user monitor thread may be generated. Each alertlet may be associated with a feature, or specific type of information, and a portal. At the alertlet, information concerning the portal may be determined. A mashup may be generated and sent based on the information.

### RELATED APPLICATIONS

The present application claims priority to U.S. Provisional Patent Application No. 61/091,384, filed on Aug. 23, 2008, entitled “A Programmable and Extensible Multi-Social Network Alert System,” the entire contents of which are hereby incorporated by reference herein.

### FIELD OF THE INVENTION

This invention generally relates to information processing, and particularly relates to providing information associated with dynamically-formed communities.

### BACKGROUND

As networked computers have become more widespread, people and organizations (e.g., businesses, non-profit organizations, and government offices) have found social uses for computers. Many social uses are associated with social-networking websites as well as many on-the-job activities. These social uses now include sharing of most, if not all, types of information that can be shared out electronically. Example social-networking websites include Yahoo!, Facebook, Twitter, MySpace, and YouTube.

Each of the social-networking websites permits individuals and/or organizations to register as users of the social-networking website. Once registered, the user may be permitted to enjoy use of various services, such as e-mail, blogging, picture and video sharing, desktop sharing, and sending of short messages. Many social-networking websites have one or more specialties that attract visitors to the website; for example, YouTube specializes in video sharing.

Additionally, many people have access to computers at work. Frequently, business activities, such as meetings, conference calls, workshops, and lectures, involve both social and electronic-communication aspects as well. One common example is an electronic meeting notice e-mailed or otherwise electronically disseminated to all persons invited to a meeting or conference call.

As the use of social-networking websites expands, social and other information related to events, topics, and/or people is divided among social-networking websites and/or work-related computers. Determining that information, such as e-mails or other messages, is available at multiple social-networking websites associated with a user often requires that the user manually access each of the social-networking websites, look for a status indication at the social-networking website about the information (e.g., “You've Got Mail”), and then review any information available at the social-networking website.

Dynamic consolidation of this information is not available in the network. To assemble all the information relevant to a user often requires manually accessing each website/computer and then, if aggregation is desired, inputting the data retrieved from each website/computer into a common document (e.g., a text file or spreadsheet) or application (e.g., a database). Manually accessing, coordinating, and/or aggregating information is often time-consuming and frequently error prone.

### SUMMARY

A first aspect of the invention is a method. A request addressed to a portal is received at an MTproxy. At the MTproxy, a user monitor thread is generated in response to the request. An alertlet associated with the user monitor thread is generated. At the alertlet, information concerning the portal is determined. A mashup is sent based on the information.

A second aspect of the invention is an apparatus. The apparatus includes a processing unit, data storage, and machine-language instructions stored in the data storage. The machine-language instructions are executable by the processing unit to perform functions. The functions include: (a) receiving a request addressed to one or more portals, (b) generating a user monitor thread in response to the request, (c) generating one or more alertlets associated with the user monitor thread, (d) determining information concerning the one or more portals, and (e) sending a mashup based on the information.

A third aspect of the invention is a tangible-computer-readable medium. The tangible-computer-readable medium has instructions stored thereon. The instructions, if executed by a processing unit, cause the processing unit to perform functions. The functions comprise: (a) receiving a request associated with a portal, (b) generating a user monitor thread in response to the request, (c) generating an alertlet associated with the user monitor thread, (d) determining information concerning the portal, and (e) sending a mashup based on the generated information.

### BRIEF DESCRIPTION OF THE DRAWINGS

Various examples of embodiments are described herein with reference to the following drawings, wherein like numerals denote like entities, in which:

FIG. 1 is an example communication network, in accordance with aspects of the invention;

FIG. 2 depicts an example MTproxy, in accordance with aspects of the invention;

FIG. 3 depicts a scenario of authenticating an MTclient, in accordance with aspects of the invention;

FIG. 4 depicts a scenario involving alert processing, in accordance with aspects of the invention;

FIG. 5 depicts a scenario involving delivery of alert information to an MTclient, in accordance with aspects of the invention;

FIG. 6 depicts an example computing device, in accordance with aspects of the invention; and

FIG. 7 is a flowchart depicting an example method, in accordance with aspects of the invention.

### DETAILED DESCRIPTION

This invention is related to alerting mechanisms to automatically correlate information from a “dynamically-formed communities” of data sources or “portals”. The portals in a dynamically-formed community may include social-networking websites, other types of web-sites, work-related computers, and other networked servers and computers. Each portal may be a source of “alerts” due to state changes in the portal and/or notifications of events related to a specific MTclient. Example alerts include, but are not limited to, messages, blog entries, friend requests and notifications, and postings to user forums.

One or more “user monitor threads” may automatically monitor and retrieve alerts generated by portals in a dynamically-formed community for a given MTclient. Each user monitor thread may use one or more “alertlets” to monitor a given portal. Each alertlet may monitor a specific “feature” of the portal. For example, if a social-networking website supports user forums and private messages only, the social-networking website may have features related to forum posting and feature related to messages.

Once an alertlet determines an alert has been generated, perhaps due to a state change at the portal, the alertlet may provide alert and/or alert-related information to the MTclient via the MT Network. The alert and/or alert-related information may be “correlated” to produce a “mashup” or correlated data item. Correlation may include prioritization, aggregation, filtering, and/or transformation of alerts. The mashup information may then be displayed or formatted in user-friendly fashion, such as a list, chart, map, e-mail format, short message format, or as requested. In particular, public alerts (e.g., blog entries, forum posting) and private alerts (e.g., messages) and/or alert-related information may be combined in a single mashup of related information.

For example, suppose a given MTclient was monitoring the location of a given person. Each location notification for the given person may include a time as well as a location of the given person. Then, in some circumstances, the location notifications for the given person may be correlated into a mashup alert, containing only the most recent location and time. The mashup may provide alert-related information as well, such as the name of the given person, a map of the current location, directions from the MTclient to the current location of the given person, and other alert-related information.

The MTclient may include a user interface for alerting. The user interface may permit selection of alerting options directed to priorities, aggregation, filtering, operations, and/or other criteria regarding alerts. Also, some or all of these alerting options may be specified in other ways by the MT Network and/or other network entities, perhaps as defaults or as “hard-coded” values.

Once the mashup has been generated based on alert(s) and/or alert-related information and application of the alerting criteria, the resulting mashup may be sent to the MTclient. The mashup may be or include an correlated data item (e.g., a table, list, or a spreadsheet). For example, a mashup may be a list of locations of friends with a map and indications of each friend's location on the map. More generally, mashups as described herein may be and/or include audio, visual, textual, and/or binary data, and may be displayed, played or otherwise presented using a variety of techniques. Some mashups may be simply displayed on a screen, while other mashups may require the use of multimedia techniques for presentation to a user. The mashup may be constructed from one or more eXtended Markup Language (XML) document(s), web page(s), graphical object(s), text file(s)/object(s), audio file(s)/object(s), video file(s)/object(s), still image file(s)/object(s), and/or using other similar techniques, objects or files. Many other examples of mashups are possible as well.

The alerting techniques and apparatus described herein enable the collection of alerts and/or alert-related information from enormous numbers of social environments as well as other on-line destinations and may deliver alerts and/or alert-related information to an MTclient based on user-specified alerting options. The alerting techniques are not necessarily tied to a specific type of messaging or networking model; for example, mashup delivery may, but does not require the use of IMAP or POP Push alerting or maintenance of persistent connections.

Parallel and decentralized processing allows for the aggregation, correlation, filtering, organization, and presentation of alerts at any point in a network; thus providing for a great deal of scalability. The scalability is based upon the ability to leverage multiple distributed processors for parallel data collection and correlation. This scalability is of significant value in social communities where alert-generation rules can range from a simple request for all alerts from all sources to a complex assembly of multiple data sources (like complex queries in data base) needed to address tailored information service requests (such as tell me if John Deerson is near by and has sent me either an e-mail from Yahoo! or an SMS message, etc). Additionally, the use of parallel and distributed processing permits scalability of communications; that is, multiple communication channels may be employed simultaneously for faster connectivity speeds and reporting of results to users of the MT Network.

An Example Communication Network

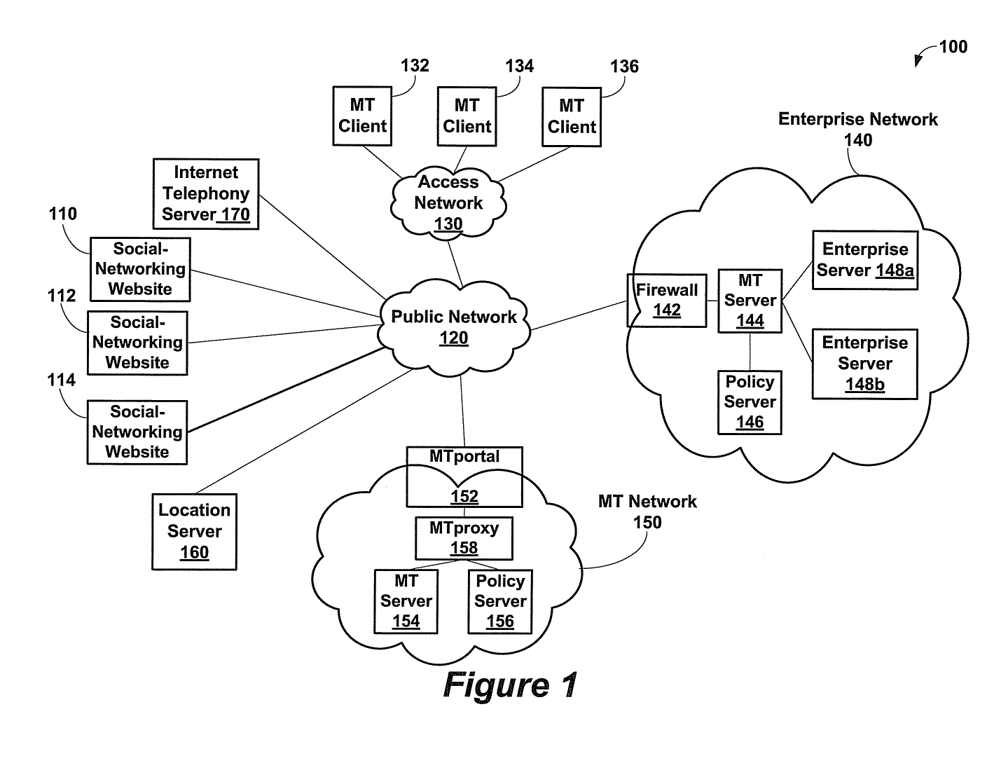

Turning to the figures, FIG. 1 is an example communication network 100, in accordance with aspects of the invention. It should be understood that this and other arrangements described herein are set forth only as examples. Those skilled in the art will appreciate that other arrangements and elements (e.g., machines, interfaces, functions, orders, and groupings of functions, etc.) can be used instead, and that some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. Various functions may be carried out by a processor executing instructions stored in memory.

As shown in FIG. 1, the example communication network 100 may include one or more social-networking websites 110, 112, and 114 each connected to a public network 120, an access network 130 connecting one or more MTclients 132, 134, and 136 to the public network 120, an enterprise network 140 connected to the public network 120, and an MT network 150 connected to the public network 120, one or more location servers 160, and one or more internet-telephony servers 170. Note that additional entities not depicted in FIG. 1 could be present as well. As an example, there may be more MTclients in communication with the public network 120, additional social-networking websites, location servers, internet-telephony servers, access networks, and/or enterprise networks in communication with public network 120. Further, there may be other data repositories, servers and websites not shown in FIG. 1 in communication with the public network 120.

There could be one or more devices and/or networks making up at least part of one or more of the communication links depicted in FIG. 1. As an example, there could be one or more routers, switches, or other devices or networks on the link between the public network 120 and the MTportal 152. Additionally, the herein-described functionalities of the public network 120 and MT Network 150 may be combined into one network.

To carry out these functions, each of the social-networking websites 110-114, MTclients 132-136, firewall 142, MTservers 144 and 154, policy servers 146 and 156, enterprise servers 148a and 148b, MTportal 152, and MTproxy 158, may take the form of a computing/communication device, such as a cell phone, personal digital assistant, wirelessly equipped personal computer, personal computer, application server, computing unit, or other entity now known or later developed configurable to carry out the herein-described functionality of a social-networking website, MTclient, firewall, MTserver, policy server, enterprise server, MTportal, and/or MTproxy.

Public network 120 may be the Internet or may comprise some other public or private packet-switched and/or circuit-switched network. Public network 120 could include any number of gateways, routers, proxies, and other intervening elements and may include one or more of the elements of the access network, enterprise network 140, and/or MT Network 150 described below.

Each MTclient 132, 134, and 136 may likewise take various forms, examples of which include the computing/communication devices listed above, and may each be configured to perform the herein-described functionality of an MTclient. The social-networking websites 110-114, MTclients 132-136, firewall 142, MT servers 144 and 154, policy servers 146 and 156, enterprise servers 148a and 148b, MT servers 144 and 154, MT location server 160, internet telephony server 170, and/or network entity 110 may be further programmed with a plurality of applications, each of which serves a discrete device function that may or may not involve user interaction. Examples of such applications include, without limitation, voice processing, image processing, word processing, phone book, calendar, spreadsheet, games, audio player, video player, web browser, image management, graphics editing, utilities, web-logs (“blogs”), online encyclopedias (“Wikis”), directory services, and other applications now known or later developed. In some embodiments, some or all of MTclients 132, 134, and 136 may have a wireless-communication interface comprising an antenna and a chipset for communicating with one or more access nodes over an air interface, such as but not limited to a GSM, UMTS, 3G, CDMA, TDMA, WiFi, WiMAX, and/or EV-DO air interface(s).

Each of the social-networking websites 110-114 may provide access to application data, such as contact lists, messages, video content, textual content, audio content, binary data, and/or other information. The access may be permitted to users that have subscribed to a given social-networking website 110-114. For example, social-networking website 110 may provide users to subscribe and then permit subscribed users to send and receive e-mail, news, and other information.

FIG. 1 shows the enterprise network 140 with firewall 142, MTserver 144, policy server 146, and enterprise servers 148a and 148b. The firewall 142 may be connected to the public network 120 and protect enterprise network 140 from unauthorized access and electronic attacks/viruses entering via the public network 120. The firewall 142 may also restrict access from within the enterprise network 140 to the public network 120; for example, the firewall 142 may not allow access to certain websites from devices within the enterprise network 140. The MTserver 144 may be connected to the firewall 142, policy server 146 and the enterprise servers 148a and 148b. The MTserver 144 and policy server 146 may perform the functions of the herein-described MTserver and policy server, respectively. Enterprise servers 148a and 148b may permit employees or other persons associated with the enterprise with e-mail to use the applications described above.

The MT Network 150 may include an MTportal 152 connect to the public network 120, an MTproxy 158 connected to the MTportal 152, the MTserver 154 and policy server 156. The MT Network 150 may be a physical network or may be an overlay network.

Note that the herein-described functionality of the MTportal, MTproxy, MTserver, and/or policy server may be combined and performed on one physical device. Similarly, multiple physical devices may be used to perform the herein-described functionality of the MTportal, MTproxy, MTserver, and/or policy server.

The MTportal 152 may provide access to the MTclients 132-136 to the MT Network 150. The MTproxy 158 may receive requests from the MTclients 132-136 and act on their behalf within the MT Network 150 to service the requests. Additionally, the MTproxy 158 may act on behalf of the MTclients 132-136 for handling events and event indications within the MT Network 150. Additionally or instead, the MTproxy 158 may perform the functions of the herein-described MTproxy.

The MTserver 154 and policy server 156 may perform the functions of the herein-described MTserver and policy server, respectively.

The MTportal 152 and/or MTproxy 158 may act to “scrub” data and/or other information sent to or from MTclients 132-136. Scrubbing data may include, but is not limited to, extracting data, transforming the data into customized content, scanning the data for viruses, spybots, cookies, and/or malicious software (a.k.a. “malware”), eliminating viruses, spybots, cookies, and/or malicious software, applying site-access rules prior to sending or receiving data, and/or filtering the data.

The data may be scrubbed according to one or more content-related rules. Example content-related rules include, but are not limited to, security-related rules, privacy-related rules, content size rules, content type rules (e.g., do not allow content with binary files of an unknown type), and/or rules regarding language(s) used in the content. The content-related rules may specify data sources and destinations (e.g., firewalls, portals, security-related servers), sizes, formats, and language(s) related to the content. The content-related rules may be selected by a user of an MTclient using appropriate user interface operations and/or by one or more network entities.

An example of applying content-related rules is to display all incoming email on a green background, except for e-mail from “MommyNearest” which is to be displayed on a blue background. Another example application of content-related rules may be to present all content in either English or Spanish, but for content received in any other language, use the translation software available at translate_for_me.org to translate the content into English before delivering the translated content to the user. A third example application of content-related rules may be to apply the user, security, and content policies available at policies.mobiletribe.com for a specific MTclient and/or specific enterprise network. Many other types of data scrubbing and content-related rules are possible as well.

An Example MTproxy

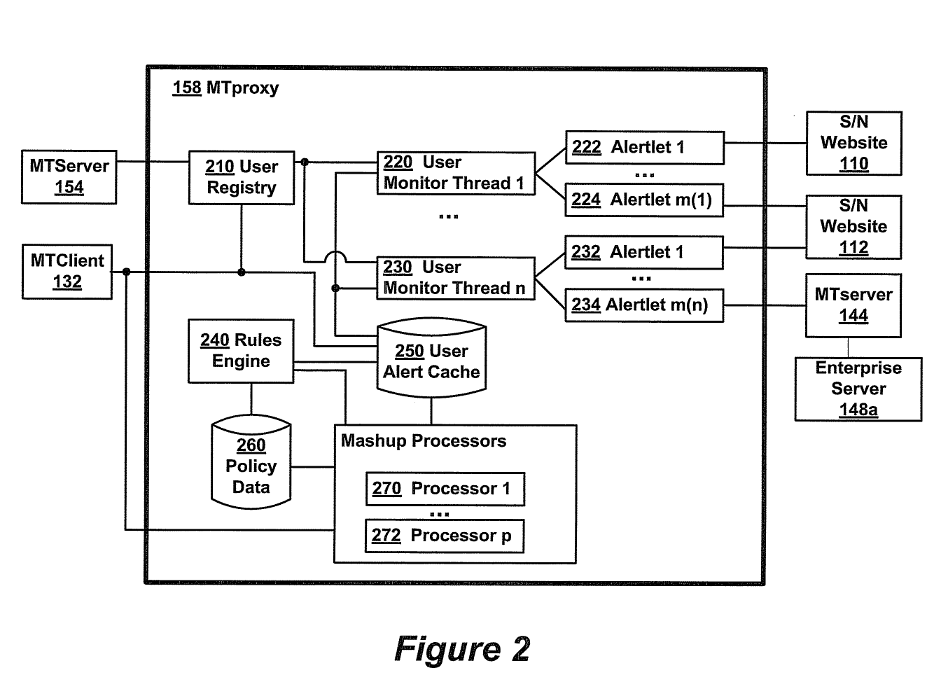

FIG. 2 depicts an example MTproxy 158, in accordance with aspects of the invention. As shown in FIG. 2, MTproxy 158 is configured to communicate with at least MTservers 144 and 154, MTclient 132, and one or more social networking (S/N) websites 110 and 112. In other embodiments, MTproxy 158 may communicate with more or fewer network entities than shown in FIG. 2.

MTproxy 158 may include a user registry 210, one or more user monitor threads 220 and 230, one or more alertlets 222, 224, 232, 234, a rules engine 240, a user alert cache 250, policy data 260, and one or more mashup processors 270 and 272. In some embodiments, user registry 210, user monitor threads 220, 230, alertlets 222, 224, 232, 234, rules engine 240, user alert cache 250, policy data 260, and/or one or more mashup processors 270 and 272 may be resident on one or more other computing device(s) than the computing device performing the operations of MTproxy 158.

FIG. 2 shows user monitor thread 230 as “user monitor thread n”, where n is a number of user monitor threads. Each user monitor thread 220, 230 may have one or more alertlets. FIG. 2 shows user monitor thread 220 with alertlet 1 222 and alertlet m(1) 224. The term “m(1)” indicates a total number of alertlets “m” for user monitor thread 1. Similarly, FIG. 2 shows user monitor thread n 230 with alertlet 1 232 and alertlet m(n) 234 for user monitor thread n 230 In some scenarios not shown in FIG. 2, n may be 0 or 1, where none or one user monitor thread is active, respectively, on MTproxy 158, and for a given user monitor thread U, m(U) may be equal to 0 or 1, indicating 0 or 1 alertlets, respectively, associated with the given user monitor thread U. Under some circumstances, one user may have multiple monitoring threads. The use of multiple monitoring threads for a given user may enable a distributed, load-balanced alert monitoring system by allowing multiple processors to process alerts for the given user.

FIG. 2 shows MTserver 154 configured to connect to user registry 210. User registry 210 may store and track information regarding to users accessing MTproxy 158. The MTserver 154 and user registry 210 may communicate data, such as user configuration data, user status information, statistical data, policy rules, content-related rules for use in data scrubbing and perhaps used for other applications, and/or updates to any or all previously-communicated data. Some or all of this data may be stored on MTserver 154 and/or user registry 210 as a “user profile”. User profiles are described in more detail in U.S. Patent application Ser. No. 12/485,688, entitled “Distributed Technique for Cascaded Data Aggregation in Parallel Fashion”, filed Jun. 16, 2009 (“the Cascaded Data Aggregation Application”), the entire contents of which are incorporated by reference for all purposes. In particular, MTserver 154 may interact with one or more specialized processes running on MTproxy 158 that coordinate communication between MTserver 154 and user registry 210.

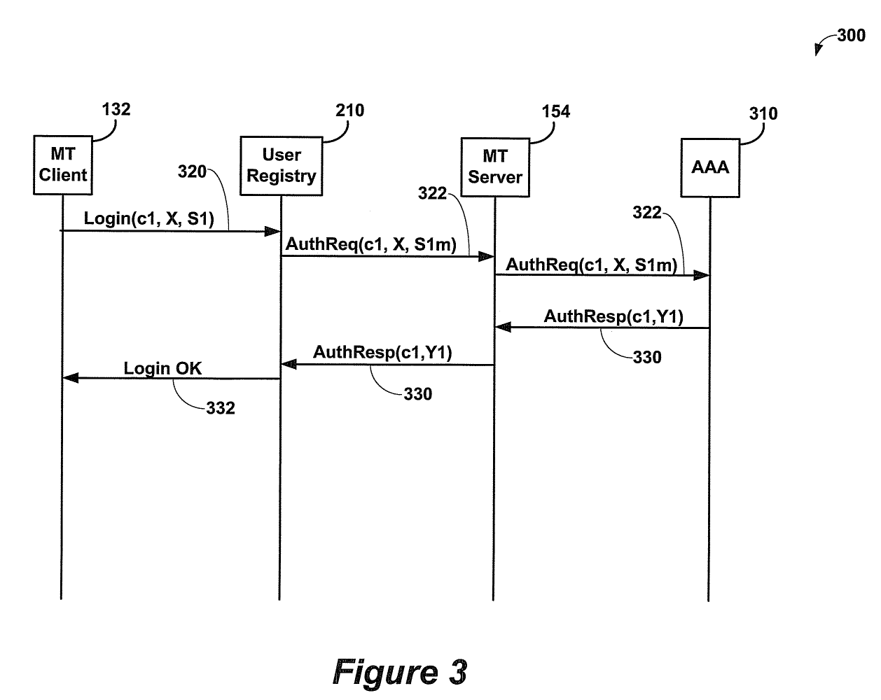

FIG. 2 shows MTclient 132 configured to communicate with user registry 210, user alert cache 250, and mashup processors 270, 272. MTclient 132 may communicate with user registry 210 as part of authentication or login processing and/or when user-related data (e.g., a user profile) is updated. Authentication processing is described in more detail with respect to FIG. 3 below.

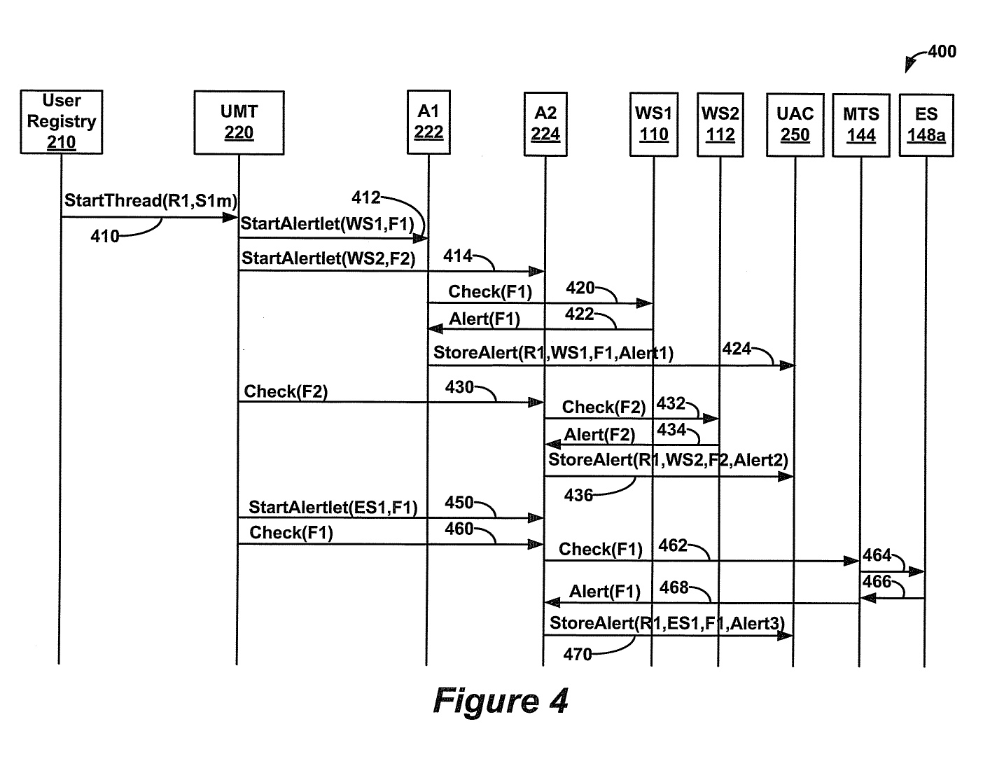

MTclient 132 may communicate with user alert cache 250 to request retrieval of alert information, to provide rules and/or policies regarding alerts, and/or to update rules and/or policies regarding alerts. In other embodiments not shown in FIG. 2, MTclient 132 may communicate with a user monitor thread (e.g., user monitor thread 220) to request retrieval of alert information, provide rules and/or policies regarding alerts, and/or to update rules and/or policies regarding alerts using procedures similar to those described herein. Retrieval and storage of alerts are described in more detail with respect to FIG. 4 below.

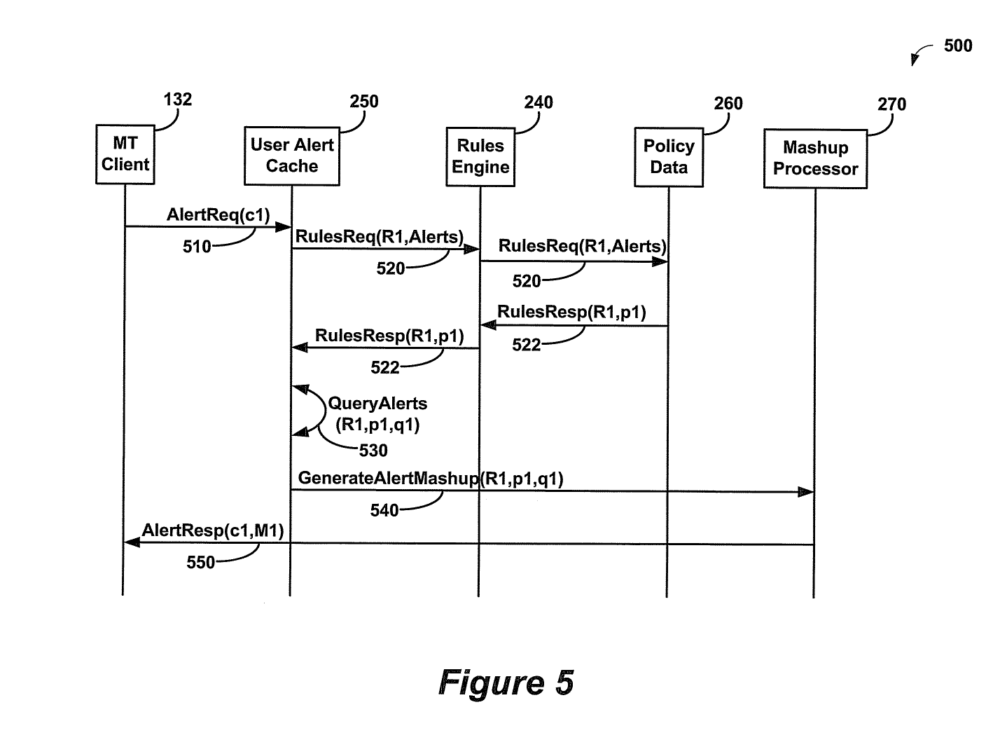

MTclient 132 may communicate with mashup processors 270, 272 to receive information, such as alert information, and perhaps to provide rules/policies regarding received information (e.g., format, types, and/or frequency of delivered alert information). Delivery of alert information to MTclient 132 is described in more detail with respect to FIG. 5 below.

FIG. 2 shows user registry 210 configured to communicate with user monitor threads 220, 230. As indicated above, each user monitor thread 220, 230 may coordinate alertlet processing. FIG. 2 shows user monitor thread 1 220 communicating with alertlets 1 . . . m(1).

Each alertlet may be configured to communicate information regarding a “feature” about a “portal”. A feature is a specific type of information requested, such as but not limited to an addressbook, blog, friend-related information, message, picture, upload-related information, download-related information, video, audio, and/or voice information. Other types of features are possible as well.

A portal is a source or destination for the specific type of information. FIG. 2 shows alertlet 1 222 with social networking website 110 as a portal, alertlet m(1) 224 and alertlet 1 232 with social networking website 112 as a portal, and alertlet m(n) 234 with enterprise server 148a as a portal via MTserver 144.

Rules engine 240 may provide rules and/or policies for MTproxy 158. The rules and/or policies may be stored in policy data 260. Rules engine 240 may be configured to retrieve, update, delete, and insert rules and/or policies for MTproxy, such as any rules and/or policies stored in policy data 260. In particular, rules engine 240 may provide rules for alert processing as described herein. FIG. 2 shows the rules engine 240 configured to communicate rules and/or polices stored in policy data 260 to user alert cache 250 and to mashup processors 270, 272. In other embodiments not shown in FIG. 2, rules engine 240 may be configured to communicate rules and/or polices to other aspects of MTproxy 158 (e.g., user registry 210, user monitor threads 220 and/or 230) and/or to other network entities other than MTproxy 158 (e.g., MTclient 132, MTserver 144, and/or MTserver 154).

FIG. 2 shows the user alert cache 250 also configured to communicate with user monitor threads 220, 230 and mashup processors 270, 272. The user alert cache 250 may be configured to receive, store, and retrieve alerts and/or alert-related information. The alerts and/or alert-related information may be received from user monitor threads 220, 230. The alerts may be received from one or more alertlets. For example, suppose alertlet 1 222 is configured to communicate information regarding an e-mail feature about social/networking website 110 and that an e-mail is received at social networking website for a user associated with MTclient 132. Then, alertlet 1 222 may be configured to communicate an alert about the received e-mail and/or alert-related information, such as time, date, size, sender, recipient, subject, body, and/or other information, regarding the received e-mail. The alert and/or alert-related information may be communicated from alertlet 1 222 to the user alert cache 250 via user monitor thread 1 220. Additional alert-related information, such as information related to social/networking website 110, MTclient 132, user monitor thread 1 220, user alert cache 250, alert status, and/or state information, may be added. The alert and/or alert-related information may be retrieved by mashup processors 270, 272 for processing and presentation to MTclient 132.

Example Scenario for an Authentication Operation

FIG. 3 depicts a scenario 300 of authenticating an MTclient 132, in accordance with aspects of the invention. Messages, requests, responses, events, event indications, and/or calls shown in scenarios 300, 400, and 500 as depicted in FIGS. 3, 4, and 5, respectively, may pass through one or more networks during their transmission. Each of the example messages, requests, responses, events, event indications, and/or calls shown in scenarios 300, 400, and 500 may have more or fewer (including no) parameters than shown in the Figures and described herein. The one or more networks include, but are not limited to, access networks, public data networks, private data networks, wired networks, wireless networks, local area networks (LANs), and wide area networks (WANs).

MTclient 132 may send a Login message 320 to user registry 210. As indicated above with respect to FIG. 2, user registry 210 may be part of MTproxy 158. FIG. 3 shows the Login message 320 includes an indication of a contact (or user) name “c1”, authentication information “X”, and state information “S1”.

The authentication information may be a password, authentication key, application key, or other similar data now known or to be discovered that acts to authenticate a contact. The state information S1 may be or include information about features, portals, operational status, alerts, and/or other kinds of information. In particular, state information S1 may include information regarding status of features; e.g., read/unread status of e-mail, a pending “poke” or inquiry about the contact c1, Short Message Service (SMS) messages, and/or other types of messages on one or more portals. The user registry 210 may use S1 to initialize or otherwise generate state information with MTproxy 158.

The state information S1 can also be used to avoid initialization states in the MTproxy and allow for massive scaling of resources, since the state is distributed to and maintained by the attached network devices. For example, a recently-connected device may connect to an MTproxy and then provide the MTproxy with prior state information, perhaps during authorization of the recently-connected device, to synchronize the state information between the MTproxy and the recently-connected device. To ensure coherence of the state information, the recently-connected device may store prior state information in non-volatile memory, such as flash memory. Upon reception of the prior state information, the MTproxy may update the given device with information about activities that have occurred since the last time the recently-connected device was connected to the MT Network. The herein-described use of distributed state information allows for a simpler and more powerful MTproxy.

At user registry 210, an authentication request (“AuthReq”) 322 is generated based on Login message 320. The AuthReq 322 may include with the contact name c1, authentication information X and/or modified state information “S1m”. S1m may be generated by updating S1 based on preference information retrieved from user registry 210. The preference information may include settings to always check e-mail from a given portal or portals regardless of the prior state information S1. Combining prior state information with preference information permits the MTproxy to provide a consistent and customizable user experience. In some scenarios, S1m may be the same as S1.

FIG. 3 shows the AuthReq 322 sent from user registry 210 and received at MTserver 154. MTserver 154 examines the AuthReq 322 and determines that the AuthReq 322 is to be processed by an Authentication, Authorization, and Accounting server (“AAA”) 310.

After receiving the AuthReq 322, the AAA 310 may verify the authentication information X for the contact name c1. Based on the verification, the AAA 310 may generate an authentication response (“AuthResp”) 330. In this scenario, a successful authentication is assumed; however, other scenarios are possible where the authentication response is unsuccessful. The AuthResp 330 provides an indication of the authenticated contact name c1 and the authentication response Y1. The authentication response Y1 may be null, may include a key, and/or may include other access information.

FIG. 3 shows that the AAA 310 sends the AuthResp 330 to the MTserver 154, which in turn sends the AuthResp 330 to user registry 210 as user registry 210 is associated with the contact having contact name c1. Upon reception of AuthResp 330, user registry 210 may generate and/or reformat AuthResp 330 into a “Login OK” message 332. Then, FIG. 3 shows the Login OK message 332 sent from the user registry 210 to the MTclient 132.

In some embodiments, the Login message 320 and AuthReq 322 are formatted in the same way; therefore, the Login message 320 and the AuthReq 322 may be identical (perhaps with more or fewer parameters). Similarly, in some embodiments, the AuthResp 330 and the Login OK message 332 may be identical.

Upon receiving Login OK message 332, MTclient 132 may be deemed as authorized to access functionality associated with AAA 310. In scenarios described with respect to FIGS. 4 and 5, any required authentication/authorization is assumed to have been performed prior to a given scenario.

An Example Scenario of Alert Processing

FIG. 4 depicts a scenario 400 involving alert processing, in accordance with aspect of the invention.

Scenario 400 begins with user registry 210 sending a “StartThread” request to a user monitoring thread (UMT) 220. StartThread request 410 may cause user monitoring thread 220 be spawned or otherwise started. FIG. 4 shows StartThread request 410 with two parameters: registry information R1 and state information S1m. State information S1m may be as described above with respect to FIG. 3. In some scenarios not shown in FIG. 4, state information S1m is not provided with StartThread request 410.

Registry information R1 may include information about features and/or portlets to be monitored by user monitoring thread 410, as well as “alert-generation rules” for generating alerts. Example alert-generation rules include:
1. Generate an alert when any feature is “activated” from any portal in registry information R1. A feature is “activated” when the state of the feature is changed. For example, an e-mail feature may be activated when an e-mail message is received, sent, read, deleted, marked as “spam”, or saved.
2. Generate an alert when any feature is activated from one or more given portals.
3. Generate an alert due to an activation from any portal a user associated with registry information is logged into. For example, a user may be logged to a work computer and to one or more social-networking websites. While accessing a social-networking website, the user may be alerted about an incoming e-mail at the work computer.
4. Generate an alert for one or more specified features are activated from one or more specified portals.
5. Generate an alert when a feature activation refers to specified keywords/other information from any portal. For example, an alert-generation rule may specify an alert be generated when the specified keyword “bank balance” is in any message received or sent from any portal listed in registry information R1.
6. Generate an alert when a feature activation refers to specified keywords/other information from one or more specified portals.
7. Generate an alert when a feature activation refers to one or more specified senders or receivers of the feature activation. For example, an alert-generation rule may specify that alert may be generated when a blog entry is created and/or other features are activated by “SuperBlogStar123”.
8. Prioritize one or more alert-generation rules over other alerts and/or other alert-generation rules. For example, a “high priority” alert may be generated when any message received or sent from any portal includes the specified keyword “bank balance”, a “medium priority alert” may be generated if the portal is a work computer or if the sender is “MySpouse”, and all other alerts may be prioritized (perhaps by default) as “regular priority”.
9. Do not generate an alert if feature is activated by one or more specified senders or receivers; e.g., do not generate alerts for any e-mail messages received at any portal from “SpamBot456” or “HideousExSpouse”.
10. Specify transformation of alerts. For example, suppose an alert may be received as an SMS message. An alert-generation rule may specify that some or all messages be transformed to HyperText Transfer Protocol (HTTP) formatted e-mail messages for delivery to an MTclient. Many other transformations of alerts are possible as well.
11. Specify aggregation of alerts. For example, a delivery timer may be specified to enhance “digesting” of alerts—that is, if multiple alerts are generated during a delivery-timer interval of time, the multiple alerts are sent to an MTclient all at once. As another example, status updates (e.g., read/unread status of messages, current location information) may be specified to be aggregated to provide only the most recent status in an alert.

Many other aggregation operations are possible as well.
12. Any Boolean combination of the above-mentioned alert-generation rules; i.e., a combination of the above-mentioned alert-generation rules joined via one or more Boolean operators (e.g., AND, OR, NOT).

The alert-generation rules may be specified by a user via a user interface of an MTclient, predefined by the MTproxy 158 and/or any components thereof, by an MTserver, and/or by other sources. The alert-generation rules may be stored in the user registry 210 and/or in other components of an MTproxy, an MTserver, and/or in other locations.

Upon reception of StartThread request 410, user monitor thread 220 may generate one or more alertlets. The user monitor thread 220 may group alertlets by “plug-in packages”, each of which is a group of one or more alertlets corresponding to features provided by a given portal. For example, a plug-in package for a portal that is an internet-telephony server may include alertlets for call-reception, caller-identification, and SMS-reception features.

The user monitoring thread 220 may schedule alertlets, such as Alertlets Al 222 and A2 224, for execution in any number of ways, i.e. sequential, in parallel, hierarchically or via any number of algorithms. For example, user monitoring thread 220 may schedule alertlets by cycling through alertlets in a scheduling order to determine which alertlet should be scheduled for execution. The scheduling order may be a numerical order (e.g., forward or numerical order based on alertlet number, feature number, portal number, etc.), an arrival-time ordering (First-In-First-OUT (FIFO), Last-In-First-Out (LIFO)), a random ordering, or some other type of ordering. The user monitoring thread 220 may schedule sequentially schedule alertlets to run one at a time and/or schedule multiple alertlets to run in parallel.

The user monitoring thread may schedule the alertlets hierarchically—for example, based on a user-defined or other definition of priorities. In some circumstances, the user may request that specific portals, features, and/or portal/feature combinations receive higher or lower priorities. The user monitoring thread 220 may then schedule the alertlets using a priority-queue or some other similar data structure to order and then schedule the alertlets according the priorities. As such, the use of priorities may enable hierarchical scheduling of alertlets. Many other types of scheduling algorithms and/or associated data structures are possible as well for scheduling of alertlets.

FIG. 4 shows user monitor thread 220 starting two alertlets A1 222 and A2 224 via StartAlertlet requests 412 and 414 respectively. A StartAlertlet request 412 and 414 may include two parameters: a portal and a feature. FIG. 4 shows StartAlertlet requests 412 and 414 have portal parameters of “WS1” and “WS2”, respectively, and feature parameters of “F1” and “F2”, respectively. A StartAlertlet request may cause an alertlet be spawned or otherwise started.

Alertlet A1 222 may check a status of feature F1 via Check message 420. Check message 420 includes one parameter—a feature indicator “F1”.

FIG. 4 shows Check message 420 generated “autonomously” by A1 222; that is, no message or other indicate external to alertlet A1 222 prompted the generation of Check message 420. The Check message 420 may have been generated due to alert-generation rules, such as expiration of a delivery timer specified in an alert-generation rule and/or based on logic and/or data internal to (e.g., hard-coded within) alertlet A1 222.

FIG. 4 shows Alert message 422 generated in response to Check message 420. Alert message 422 includes one parameter—a feature indicator “F1”. Alert message 422 may include alert-related information as well.

Upon reception of Alert message 422, alertlet A1 222 may store the alert. FIG. 4 shows alertlet A1 222 sending StoreAlert message 424 to user alert cache (UAC) 250. StoreAlert message 424 may include registry information R1, portal information WS1, feature information F1, and alert and/or alert-related information Alert1. Upon reception of StoreAlert message 424, the user alert cache 250 may store alert and/or alert-related information Alert1, as well as registry information R1, portal information WS1, and/or feature information F1. The user alert cache 250 may generate and/or store other alert-related information as well based on StoreAlert message 424, such as a time when StoreAlert message 424 is received or a size of alert and/or alert-related information Alert1. User alert cache 250 may also aggregate one or more other alerts based on StoreAlert message 424. In some embodiments not shown in FIG. 4, user alert cache 250 may send an acknowledgement regarding StoreAlert message 424 back to alertlet A1 222.

FIG. 4 shows user monitor thread 220 scheduling alertlet A2 224 for execution by sending Check message 430 regarding a feature F2 to alertlet A2 224. In response to Check message 430, Check message 432 regarding feature F2 was sent from alertlet A2 224 to website (portal) 112. Note that Check message 432 was not generated autonomously by A1 222; that is, Check message 430 prompted the generation of Check message 432.

FIG. 4 shows Alert message 434 generated in response to Check message 432. Alert message 434 includes one parameter—a feature indicator “F2”. Alert message 434 may include alert-related information as well. Upon reception of Alert message 434, alertlet A2 224 may store the alert. FIG. 4 shows alertlet A2 224 sending StoreAlert message 436 to user alert cache 250, with registry information R1, portal information WS2, feature information F2, and alert and/or alert-related information Alert2. User alert cache 250 may process StoreAlert message 436 in a similar fashion to that described above with respect to StoreAlert message 424.

In another scenario, user monitoring thread 220 may start alertlet A1 222 to communicate with an enterprise server as a portal, perhaps via an MTserver. FIG. 4 shows this scenario beginning with StartAlertlet message 450 sent from user monitor thread 220 to alertlet A1 222 with portal information ES1 and feature information F1. FIG. 4 shows that at a later time, user monitor thread 220 schedules alertlet A1 222 for execution by sending a Check message 460 with feature information F1 to alertlet A1 224. Alertlet A1 224 then generates a corresponding Check message 462 regarding feature F1 to MTserver (MTS) 144 within enterprise network 140. MTserver 144 then forwards on Check message 462 as message 464 to enterprise server (ES) 148a. FIG. 4 shows that enterprise server 148a sends message 466 in response to message 464 to MTserver 144. MTserver then sends an Alert message 468 regarding feature F1 to alertlet A1 222. FIG. 4 shows alertlet A1 222 sending a StoreAlert message 470 to user alert cache 250 to store the alert, with registry information R1, portal information ES1, feature information F1, and alert and/or alert-related information Alert3. User alert cache 250 may process StoreAlert message 470 in a similar fashion to that described above with respect to StoreAlert message 424.

In other scenarios not shown in FIG. 4, alertlets A1 222 and A2 224 may store alerts and/or alert-related information locally instead of sending StoreAlert messages. In still other scenarios, alerts and/or alert-related information may be stored by user monitoring thread 230.

An Example Scenario for Delivery of Alert Information

FIG. 5 depicts a scenario 500 involving delivery of alert information to an MTclient, in accordance with aspects of the invention.

Scenario 500 start with an AlertReq message 510 for an alert request sent from MTclient 132 to user alert cache 250. AlertReq message 510 includes contact indication c1. Upon reception of AlertReq message 510, user alert cache 510 generates a request for rules and/or policies regarding alerts for MTclient132. As part of generation of the request for rules and/or policies, the user alert cache 250 may communicate with user registry 210 to receive registry information R1 regarding contact indication c1.

FIG. 5 shows user alert cache 250 sending a RulesReq message 520 to rules engine 240 to request rules and/or policies. The RulesReq message 520 may include two parameters: registry information R1 and a type of rules and/or policies sought. FIG. 5 shows the type of rules and/or policies sought are “Alerts”; that is RulesReq message 520 rules and/or policies regarding alerts for an MTclient associated with registry information R1. Other types of rules and/or policies are possible as well. FIG. 5 shows that rules engine 240 forwards on RulesReq message 520 on to policy data 260 to retrieve rules and/or policies regarding alerts for an MTclient associated with registry information R1.

FIG. 5 shows policy data 260 sending a RulesResp message 522 to rules engine 240 in response to RulesReq message 520. RulesResp message 522 includes two parameters: registry information R1 to permit the rules engine 240 and alert cache 250 to correlate the RulesResp message 522 with the corresponding RulesReq message 520 and the sought-after rules and/or policies p1. Rules engine 240 forwards on RulesResp message 522 to the user alert cache 250.

FIG. 5 shows user alert cache 250 performing an internal query using QueryAlerts message 530 after receiving RulesResp message 522. QueryAlerts message 530 has three parameters: the registry information R1,, the sought-after rules and/or policies p1, and a query result q1. The internal query may look up all stored alerts and/or alert-related information for an MTclient associated with registry information R1 and apply the sought-after rules and/or policies p1 to generate the query result q1.

FIG. 5 shows a GenerateAlertMashup message 540 sent from user alert cache 250 to mashup processor 270. The GenerateAlertMashup message 540 has three parameters: registry information R1, policy information p1, and query result q1.

In response to GenerateAlertMashup message 540, mashup processor 270 may generate a mashup M1 with some or all of the alert(s) and/or alert-related information in query result q1.

Mashup processor 270 may generate mashup M1 in accordance with one or more alerting options. Alerting options may include, but are not limited to, options and criteria for priorities of alerts, aggregation criteria, filtering criteria (e.g., allow or deny delivery of messages from a given sender), message transformation criteria (e.g., transform e-mail messages to SMS messages or vice versa), formatting options, operation criteria, compression options and/or encryption options. The alerting options may include content-related rules for data scrubbing as described above in more detail with respect to FIG. 1. Alerting options may include options and criteria for delivery of alert-related information mashup for an alert, such as maps or directions for an alert related to locations, contact entries for alerts related to messages. The formatting options may provide information for format of a mashup, such as use of audio, video, textual and/or other data (e.g., playing a specific ringtone or other audio data for alerts related to given topic(s) and/or person(s), a green background for messages related to bank balances or from BigBank.com, font sizes/styles, sending and/or storage of encryption keys, etc.)

Operation criteria may include criteria to regulate delivery of alerts. Operation criteria may specify periodic generation of alert requests or mashups, limit the number of alerts sent to prevent device flooding, and/or save radio device power by controlling the frequency of alert notification. Other operation criteria may be used as well. Operation criteria may be used to control either autonomous sending of mashups or non-autonomous sending of mashups (e.g., to control alert requests that in turn generate sending of mashups). The operation criteria may be selected by a user of an MTclient using appropriate user interface operations and/or by one or more network entities as indicated above.

Compression and encryption options may be related to data compression and/or encryption techniques, perhaps to be applied after correlation. Example data compression techniques include lossless compression techniques, lossy compression techniques, run-length encoding, Lempel-Ziv coding, Lempel-Ziv-Welch coding, Huffman coding, arithmetic-coding-based compression, JBIG compression, and inverse-arithmetic coding. Example encryption techniques include DES, AES, MD4, MD5, SHA algorithms, Diffie-Hellman, RSA, DSA, one-time pads, and steganographic techniques. Many other data compression and/or encryption techniques may also or instead be applied as well.

The alerting options and criteria may be selected using a user interface and/or by one or more network entities. The one or more network entities may include entities within the MT Network (e.g., MTproxy, MTserver, MTclient). Some alerting options and criteria may be “static” or unchanging (i.e., hard-coded), while others may be “dynamic” or subject to change, perhaps via the user interface or via software control of alerting options.

FIG. 5 shows mashup M1 sent to MTclient 132, along with contact indication c1, in an AlertResp message 550. Upon reception of AlertResp message 550, MTclient 132 may display and/or otherwise present mashup M1 to one or more persons using a device operating MTclient 132.

The user alert cache 250 and/or mashup processor 270 may “correlate” alerts prior to sending AlertResp message 550 including mashup M1 to MTclient 132. Correlation may include prioritization, aggregation, filtering, and/or transformation of alerts, such as described in more detail in the discussion of alert-generation rules above with respect to FIG. 4. In some aspects of the invention, correlation of alerts may be performed by applying alert-generation rules to some or all alerts at an MTserver, an MTproxy (including but not limited application at an alertlet, a user monitor thread, a user alert cache, a rules engine, policy data, and/or at a mashup processor), and/or an MTclient.

In the scenario shown in FIG. 5, GenerateAlertMashup message 540 and corresponding AlertResp message 550 is sent in response to AlertReq 510. In other scenarios not shown in FIG. 5, GenerateAlertMashup message 540 and/or AlertResp message 550 may be generated and sent autonomously by user alert cache 240 and/or mashup processor 270, respectively, to be sent to MTclient 132. For example, a GenerateAlertMashup message 540 and corresponding AlertResp message 550 may be generated and sent autonomously when a high-priority alert is stored in user alert cache 250. In still other scenarios, the mashup M1 may be “piggybacked” or added to a message destined for MTclient 132. In these scenarios, the mashup M1 may be delivered to MTclient 132 without use of an explicit response to the AlertReq 510 message; i.e., the GenerateAlertMashup message 540 may not be sent when mashup M1 is piggybacked onto another message.

An Example Computing Device

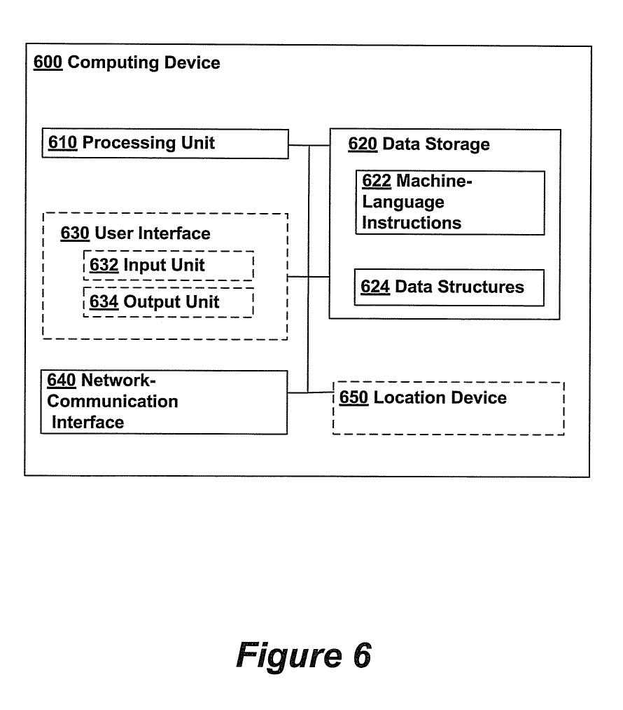

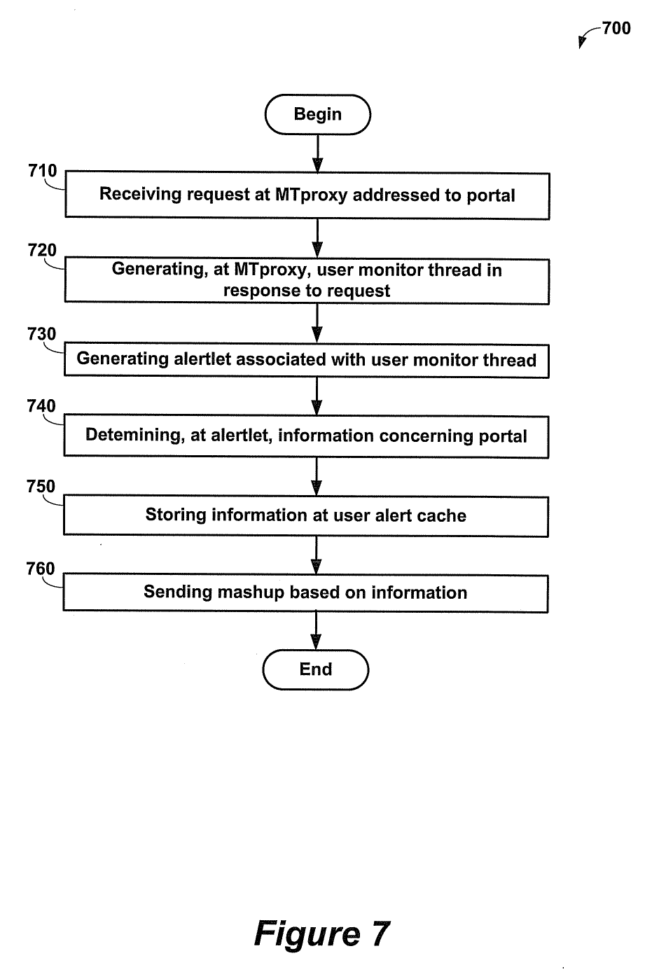

FIG. 6 is a block diagram of an example computing device 600, comprising a processing unit 610, data storage 620, a user interface 630, and a network-communication interface 640, in accordance with aspects of the invention. A computing device 600 may be a desktop computer, laptop or notebook computer, personal data assistant (PDA), mobile phone, embedded processor, or any similar device that is equipped with a processing unit capable of executing computer instructions to perform at least part of any or all of the herein-described methods and scenarios, scenarios depicted in FIGS. 3, 4, and 5 and method 700 as depicted in FIG. 7, and/or herein-described functionality of an MTserver, MTclient, MTportal, MTproxy, policy server, social-networking website, location server, internet telephony server, access network, public network, firewall and/or enterprise server.

The processing unit 610 may include one or more central processing units, computer processors, mobile processors, digital signal processors (DSPs), application-specific integrated circuits (ASICs), graphics processing units (GPUs), microprocessors, computer chips, integrated circuits, and similar processing units now known and later developed and may execute machine- language instructions and process data.

The data storage 620 may comprise one or more storage devices. The data storage 620 may include read-only memory (ROM), random access memory (RAM), flash memory, magnetic-disk memory, optical-disk memory, removable-disk memory, magnetic-tape memory, paper cards, and similar storage devices now known and later developed. The data storage 620 may be removable and/or dedicated. As such, the data storage 620 may include one or more tangible computer-related media configured to store some or all of the machine language instructions described herein. The data storage 620 comprises at least enough storage capacity to contain machine-language instructions 622 and data structures 624.

The terms tangible computer-readable medium and tangible computer-readable media, as used herein, refer to any tangible medium that can be configured to store instructions, such as machine-language instructions 622, for execution by a processing unit and/or computing device; e.g., processing unit 610. Such a medium may take many forms, including but not limited to, non-volatile media and volatile media. Non-volatile media includes, for example, ROM, flash memory, magnetic-disk memory, optical-disk memory, removable-disk memory, magnetic-tape memory, and paper cards. Volatile media include dynamic memory, such as main memory or RAM. As such, the herein-described data storage 620 may comprise and/or be one or more tangible computer-readable media.

The machine-language instructions 622 and the data structures 624 contained in the data storage 620 include instructions executable by the processing unit 610 and any storage required, respectively, at least part of any or all of the herein-described methods and scenarios, scenarios depicted in FIGS. 3, 4, and 5, method 700 depicted in FIG. 7 and/or herein-described functionality of an MTserver, MTclient, MTportal, MTproxy, policy server, social-networking website, location server, internet telephony server, access network, public network, firewall and/or enterprise server.

The user interface 630 may comprise an input unit 632 and/or an output unit 634. The user interface 630 is an optional component of computing device 600, as indicated with dashed lines. The input unit 632 may receive user input from a user of the computing device 600. The input unit 632 may comprise a keyboard, a keypad, a touch screen, a computer mouse, a track ball, a joystick, and/or other similar devices, now known or later developed, capable of receiving user input from a user of the computing device 600.

The output unit 634 may provide output to a user of the computing device 600. The output unit 634 may comprise a visible output device, such as one or more cathode ray tubes (CRT), liquid crystal displays (LCD), light emitting diodes (LEDs), displays using digital light processing (DLP) technology, printers, light bulbs, and/or other similar devices, now known or later developed, capable of displaying graphical, textual, and/or numerical information to a user of computing device 600. The output unit 634 may alternately or additionally comprise one or more aural output devices, such as a speaker, speaker jack, audio output port, audio output device, earphones, and/or other similar devices, now known or later developed, capable of conveying sound and/or audible information to a user of computing device 600.

The network-communication interface 640 is configured to send and receive data and may include a wired-communication interface and/or a wireless-communication interface. The wired-communication interface, if present, may comprise a wire, cable, fiber-optic link or similar physical connection to a wide area network (WAN), a local area network (LAN), one or more public data networks, such as the Internet, one or more private data networks, or any combination of such networks. The wireless-communication interface, if present, may utilize an air interface, such as an IEEE 802.11 (e.g., Wi-Fi) and/or IEEE 802.16 (e.g., WiMax) interface to a WAN, a LAN, one or more public data networks (e.g., the Internet), one or more private data networks, or any combination of public and private data networks.

The computing device 600 may also comprise a location device 650. The location device 650 is an optional component of computing device 600, as indicated with dashed lines. The location device 650 may utilize one or more technologies and techniques to determine a current position, including but not limited to Global Positioning System (GPS), gyroscopes, dead reckoning techniques, magnetic devices such as compasses, landmark comparison processes, lasers (including range finders and ring gyroscopes), and/or radio-frequency waves. Other techniques and technologies for determining the current position of the location device are possible as well. The location device 650 may report the determined current position to the processing unit 610 and/or store the current position in the data storage 620.

An Example Method for Alert Processing

FIG. 7 is a flowchart depicting an example method 700, in accordance with aspects of the invention. Method 700 may describe processing of alerts and/or alert-related information due to state changes in one or more portals and/or notifications of events related to a specific MTclient. Example alerts include, but are not limited to, messages, blog entries, friend requests and notifications, and postings to user forums.

It should be understood that each block in this flowchart and within other flowcharts presented herein may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

Method 700 may begin at block 710. At block 710, a request addressed to a portal may be received. The request may be received at an MTproxy. The request may be a login request described above in more detail with respect to FIG. 3, an alert request described above in more detail with respect to FIG. 5, and/or another type of request.

At block 720, a user monitor thread may be generated in response to the request. The user monitor thread may be generated at an MTproxy. User monitor threads are described above, in particular with respect to FIGS. 2 and 4.

At block 730, an alertlet may be generated. The alertlet may be associated with the user monitor thread. The alertlet may be generated at an MTproxy. Alertlets are described above, in particular with respect to FIGS. 2 and 4.

At block 740, information concerning the portal may be determined. The information concerning the portal may be determined by the alertlet. Determination and generation of information of regarding portals by alertlets is described above, in particular with respect to FIGS. 2 and 4.

At block 750, the information concerning the portal may be stored. The information concerning the portal may be stored at the alertlet, the user monitor thread and/or at a user alert cache. Storage of information concerning the portal is described above, in particular with respect to FIGS. 2 and 4.

At block 760, a mashup is sent based on the information. The mashup may be generated by a mashup processor. Generation and sending mashups based on generated information are described above, in particular with respect to FIG. 5. The mashup may be generated based on one or more alert-generation rules. Alert-generation rules are discussed above with respect to FIGS. 4 and 5. The mashup may conform to one or more alerting options, which are discussed above in more detail with respect to FIG. 5. The information may be scrubbed using one or more content-related rules before sending the mashup and/or before the mashup is generated. Data scrubbing and content-related rules are described above in more detail with respect to FIG. 1.

After completing the procedures of block 760, method 700 may end.

Exemplary embodiments and aspects of the present invention have been described above. Those skilled in the art will understand, however, that changes and modifications may be made to the embodiments and aspects described without departing from the true scope and spirit of the present invention, which is defined by the claims. It should be understood, however, that this and other arrangements described in detail herein are provided for purposes of example only and that the invention encompasses all modifications and enhancements within the scope and spirit of the following claims. As such, those skilled in the art will appreciate that other arrangements and other elements (e.g. machines, interfaces, functions, orders, and groupings of functions, etc.) can be used instead, and some elements may be omitted altogether.

Further, many of the elements described herein are functional entities that may be implemented as discrete or distributed components or in conjunction with other components, in any suitable combination and location, and as any suitable combination of hardware, firmware, and/or software.

We claim:

1. A method, comprising:
receiving a request addressed to a portal at an MTproxy;
generating, at the MTproxy, a user monitor thread in response to the request;
generating an alertlet associated with the user monitor thread;
determining, at the alertlet, information concerning the portal;
sending a mashup based on the information.

2. The method of claim 1, further comprising:
storing the information in a user alert cache.

3. The method of claim 2, wherein storing the information comprises correlating the information.

4. The method of claim 1, wherein sending the mashup comprises:
correlating the generated information based on an alert-generation rule;
generating the mashup based on the aggregated information; and
sending the generated mashup.

5. The method of claim 4, wherein the alert-generation rule comprises a predefined priority, and wherein correlating the generated information comprises prioritizing the generated information based on the predefined priority.

6. The method of claim 4, wherein the alert-generation rule comprises an aggregation rule, and wherein correlating the generated information comprises aggregating the generated information based on the aggregation rule.

7. The method of claim 4, wherein the alert-generation rule comprises a predefined filter, wherein correlating the generated information comprises filtering the generated information based on the predefined filter.

8. The method of claim 4, wherein the alert-generation rule comprises a desired- formatting rule, wherein correlating the generated information comprises transforming the generated information from an input-message format to a desired mashup-message format based on the desired-formatting rule.

9. The method of claim 1, wherein generating information concerning the portal comprises:
scheduling, at the user monitor thread, the alertlet;
responsive to the scheduling, monitoring the portal via the alertlet; and
generating the information from the monitored portal.

10. The method of claim 1, wherein sending the mashup based on the information comprises:
scrubbing the information based on a content-related rule; and
generating a mashup based on the scrubbed information; and
sending the generated mashup.

11. A MTproxy, comprising:
a processing unit;
data storage; and
machine-language instructions, stored in the data storage, executable by the processing unit to perform functions, the functions comprising:
receiving a request addressed to one or more portals;
generating a user monitor thread in response to the request;
generating one or more alertlets associated with the user monitor thread;
determining information concerning the one or more portals;
sending a mashup based on the information.

12. The MTproxy of claim 11, wherein the request comprises state information.

13. The MTproxy of claim 12, wherein the request comprising the state information is received from an MTclient, wherein the MTclient is configured to store the state information, and wherein the functions further comprise:
updating the state information based on user-registry information.

14. The MTproxy of claim 12, wherein the functions further comprise determining an MTproxy-state based on the state information.

15. The MTproxy of claim 11, wherein determining information concerning the one or more portals comprises updating the MTproxy-state for at least one of the one or more portals.

16. The MTproxy of claim 15, wherein sending the mashup comprises sending a mashup that comprises the MTproxy-state.

17. The MTproxy of claim 11, wherein generating one or more alertlets comprises:
for each given portal of the one or more portals, generating one or more associated alertlets, wherein each associated alertlet associated with the given portal.

18. The MTproxy of claim 17, wherein each of the one or more associated alertlets is further associated with a feature of the given portal.

19. The MTproxy of claim 11, wherein generating the user monitor thread comprises:
retrieving user data for a user associated with the request from a user registry; and
generating the user monitor thread based on the user data.

20. A tangible-computer-readable medium having stored thereon instructions that, if executed by a processing unit, cause the processing unit to perform functions comprising:
receiving a request addressed to a portal;
generating a user monitor thread in response to the request;
generating an alertlet associated with the user monitor thread;
determining information concerning the portal; and
sending a mashup based on the generated information.
